(19) United States
(12) Patent Application Publication
(10) Pub. No.: US 2005/0082370 A1
(43) Pub. Date: Apr. 21, 2005

(54) System and method for decoding barcodes using digital imaging techniques

(76) Inventors: Didier Frantz, New York, NY (US); Prateek Shrivastava, Newark, NJ (US); Ashish Muni, Flushing, NY (US); Avi Outmezguine, Brooklyn, NY (US)

Correspondence Address: SCANBUY, INC., 54 WEST 39TH STREET, FOURTH FLOOR, NEW YORK, NY, 10018, US

(21) Appl. No.: 10/796,153

(22) Filed: Mar. 10, 2004

Related U.S. Application Data
(60) Provisional application No. 60/511,703, filed on Oct. 17, 2003.

(51) Int. Cl. G06K 7/10; G06K 9/22; G06K 19/06; G02B 26/10

(52) U.S. Cl. 235/462.25

(57) ABSTRACT

The present invention discloses a system and method for decoding barcodes from images acquired using a mobile device. Generally, the barcode image is acquired via a digital camera attached to the mobile device. After the barcode image has been acquired, the image is sent to a server via a wireless network which enhances the barcode image and subsequently decodes the barcode information. The server processes the barcode information and transmits media content related to the barcode back to the mobile device.

### PARENT CASE TEXT

This application claims the benefit of provisional application No. 60/511,703 filed Oct. 17, 2003.

### FIELD OF THE INVENTION

The present invention relates generally to the field of barcode scanning and analyzation using a mobile device. More specifically, the present invention operates by acquiring barcode images using a camera phone, sending the barcode images to a server, and subsequently decoding the barcode information from the barcode images.

### BACKGROUND OF THE INVENTION

Barcodes have been utilized for identifying and pricing objects for more than thirty years. Most typically, barcodes are used in retail to identify the price of an item of merchandise. For example, a gallon of milk may contain a barcode that, when scanned, will notify the cashier of the price of the milk.

Yet in recent years, barcodes have acquired new purposes as computers and barcode scanners have become more portable. The circuitry required to scan a conventional one-dimensional barcode can now be housed in a device as small as a typical keychain. As a result, many mobile telephones, personal digital assistants (“PDAs”), and pagers can be retrofitted with or connected to a laser-based scanning device. This allows the mobile device to function as a scanner capable of storing hundreds or thousands of scanned barcodes.

Mobile devices with attached scanners have allowed for the development of a new niche in the wireless electronics business. Some companies have developed software and hardware which allows a user to scan any barcode and be redirected to media information (e.g., a website, product description, price, etc.) about the scanned product. These programs provide a link between the physical and online world which previously did not exist.

However, mobile devices with attached scanners possess some drawbacks which have curtailed their expansion into the mobile marketplace. First, there are few mobile devices produced for the general public that contain integrated laser-based scanners. Therefore, for a user to acquire scanning capability for a mobile device, he/she must purchase additional equipment. The additional scanning equipment also adds size and weight to the mobile device, thereby reducing its mobility.

Currently, many cell phones and mobile devices are available with built-in cameras. The explosion of the availability of affordable digital cameras and their inclusion into mobile devices is driven by several factors. One of the most important is the recent availability of inexpensive image sensors based on CMOS technology. The cameras on these devices provide a means for capturing the barcode information which was previously only accessible via a laser-based scanner. Decoding barcode images from digital cameras included in mobile devices presents several difficult problems. These problems go well beyond the challenges addressed in commercial barcode readers. Barcode decoding algorithms from commercial products will not consistently decode images from a consumer portable device. Some of these problems are addressed below:

Lighting:

Most mobile devices with integrated digital cameras do not have built-in flashes and rely solely on the ambient light for illumination. Using highly variable ambient light makes pattern recognition much more difficult. Shadows, shading across the length of a barcode, overexposure, underexposure, and similar problems that are typical of any camera not utilizing a flash can foil traditional barcode decoding algorithms that are designed for highly controlled lighting environments.

Size:

The distance between a digital camera and its target object is not usually rigidly controlled. This translates into a large range of possible sizes (magnifications) that a barcode can have on a fixed size image sensor.

Skew:

As any photographer knows, taking pictures at an angle changes the apparent shape of the object to a viewer. A barcode with a rectangular shape, when viewed straight-on, can look like a trapezoid (or irregular quadrilateral) when viewed from an angle. The location and addressing of image pixels for a barcode change dramatically when viewed from the side, or tilted. Algorithms to decode barcodes from digital images must be able to address images distorted from skewed viewing angles.

Color Imagers:

Consumer oriented devices such as mobile handsets generally are designed with color image sensors. However, barcode scanning typically operates best with gray-scale information. Color data typically requires three times the amount of storage and handling required by gray-scale. Data needs to be transferred through the camera's CPU and memory to be processed. For color imagers, specific image processing algorithms are required in order to avoid problematic image artifacts during the translation from color to grayscale.

Focus:

Digital cameras for portable devices are usually designed to work at a variety of distances. The need for a wider range of focus in cameras results in a trade off between the cost of the lens component and the sharpness of a typical image. Decoding algorithms for embedded digital cameras must be able to cope with a moderate degree of focus problems.

Low-Cost Lens Components:

In order to meet cost constraints of many portable device markets, manufacturers often compromise on the optical quality of camera lenses. This can present decoding technology with a different set of challenges from the simple focal length based focus problem noted above. Low-cost lens components can produce image distortions that are localized to a specific region or form a changing gradient across the image. This requires additional sophistication for decoding algorithms.

Limited resolution:

The cost of a digital imaging CMOS sensor increases as the number of image pixels increases. Although the Asian market has seen the release of general purpose consumer devices like PDAs and cell phones with “megapixell” image resolution, it is unlikely these devices will be released in the mainstream European and North American markets in the near future. With fewer pixels to work with, it is significantly more difficult to reliably decode barcodes from images.

Limited Processing Power:

Decoding barcodes from images requires a great deal of processing power to correctly extract the barcode information from the image. Most camera phones do not have this level of processing power mainly due to size constraints. Also, processing digital images would greatly reduce the battery life of the mobile device.

Access:

In many instances, mobile devices do not include an application program interface (“API”) for the integrated digital camera. Therefore, access to the control and function of the camera may be prohibited. Without direct control of the functions of the camera, it would be difficult to develop programs specifically for the mobile device which are capable of decoding barcodes.

Based on the aforementioned described problems with mobile devices and digital imaging, there clearly exists a need for a system capable of capturing, decoding, and analyzing barcode information obtained from a digital camera enabled mobile device. Such a system would enable the average mobile device user to accurately and reliably scan and decode any barcode available.

### SUMMARY OF THE INVENTION

The present invention provides a system and method designed to successfully process and decode barcodes acquired via digital imaging techniques. The invention empowers a user to use a cell-phone or PDA equipped with a digital camera to scan barcodes (one-dimensional and two-dimensional) or any other similar machine-readable code. The image acquired with the digital camera (built-in or attached) of the cell phones/PDAs/Pocket PCs is sent to a server via a wireless network and subsequently decoded to extract the barcode information. This information is then processed by the server and relayed back to the user in a variety of ways.

To utilize the system of the present invention, a user first initializes the digital camera on the camera phone by loading an image acquisition program. Using the viewfinder provided by the image acquisition program, the user takes a picture of the desired barcode. Once the image has been acquired, the user sends the image to a server via a wireless network for decoding. Currently, most camera phones and PDAs utilize XML to transfer digital images through a wireless network. However, any protocol which allows a digital image to be transferred from the camera phone to the server wirelessly may be used with the present invention.

Software located on the server (hereinafter referred to as “ScanZoom”) decodes the barcode utilizing a decoding engine integral to the ScanZoom software. The barcode decoding engine continuously runs in a loop until it's able to decode barcode information from the barcode image. If the barcode cannot be properly resolved, the user is prompted to take another picture of the desired barcode.

After the barcode has been correctly resolved by the server, the server processes the barcode information accordingly. For example, the server may utilize the barcode information to search for product information in a product database or search engine. Alternatively, the server may utilize the barcode information to search multiple vendors for the lowest available price of the scanned product. As should be evident to one skilled in the art, the barcode information may be utilizes in an almost limitless variety of ways by the server.

After the server has processed the barcode information, the media content is then sent back to the user via the wireless network. The media content displayed to the user depends entirely on the barcode scanned. For example, if a user scans a barcode on a compact disc, the ScanZoom application may send a MMS message to the camera phone which directs the WAP browser located on the camera phone website which allows the user to purchase the compact disc electronically. As another example, if a user scans a barcode located on a food item, the server may return a SMS message to the mobile device indicating the nutritional contents of the scanned item.

Therefore, it is an object of the present invention to provide a system and method capable of accurately and reliably decoding barcodes and other machine-readable codes acquired via a digital camera connected to a mobile device.

Another object of the present invention is to provide a software application and system which allows for the decoding of barcodes in a wide range of conditions.

Yet another object of the present invention is to provide a system and method for decoding barcodes which does not require any software to be installed on the mobile imaging device.

An additional object of the present invention is to provide a method and system for decoding barcodes which is quick and responsive.

Yet another object of the present invention is to provide a method and system for decoding barcodes which is robust under adverse lighting, imaging, and focusing conditions.

Still another object of the present invention is to provide a method and system for decoding multiple barcode formats.

Another object of the present invention is to provide a method and system which does not adversely affect device performance, usability, or form factor.

Furthermore, an object of the present invention is to provide a method and system for decoding barcodes which does not significantly impact device power consumption nor degrade general camera performance.

It is another object of the present invention to provide a barcode decoding system which requires minimal or no changes to the manufacturing process of the mobile devices.

An additional object of the present invention is to provide a barcode decoding system having a low incremental cost per device.

Another object of the present invention is to provide a highly reliable barcode decoding system requiring minimal user support.

These and other objects of the present will be made clearer with reference to the following detailed description and accompanying drawings.

### BRIEF DESCRIPTION OF THE DRAWINGS

FIG. 1 depicts a schematic diagram of the network configuration utilized in the preferred embodiment of the invention.

FIG. 2 depicts a flowchart showing the steps the ScanZoom software utilizes to image and decode a barcode.

FIG. 3 depicts a schematic diagram showing the product architecture of the ScanZoom software application.

FIG. 4A depicts a flowchart showing the process utilized by the decoding engine to enhance an image before decoding.

FIG. 4B depicts a flowchart showing the process utilized by the decoding engine to decode a barcode.

FIG. 5A depicts a flowchart showing the process utilized by the ScanZoom software to sharpen an image.

FIG. 5B depicts a typical barcode image acquired using a digital camera.

FIG. 5C depicts the barcode of FIG. 5B after it has undergone sharpening utilizing the sharpening filter depicted in FIG. 5A.

FIG. 6 depicts a flowchart showing a specific example of the process utilized by the decoding engine for UPC-A barcodes.

FIG. 6A depicts a flowchart showing the “forced decoding” depicted in FIG. 6.

### DETAILED DESCRIPTION OF THE PREFERRED EMBODIMENT(S)

The following presents a detailed description of a preferred embodiment (as well as some alternative embodiments) of the present invention. However, it should be apparent to one skilled in the art that the described embodiment may be modified in form and content to be optimized for a wide variety of situations.

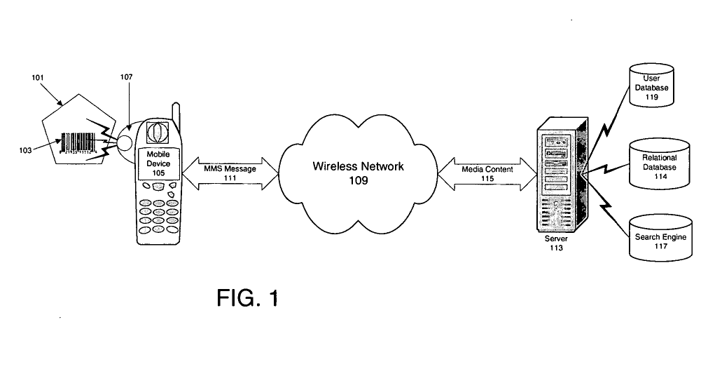

With reference first to FIG. 1, shown is a schematic diagram of the network configuration utilized in the preferred embodiment of the present invention. In this figure, product 101 contains barcode 103 which may be placed on product 101 in a variety of ways. For example, barcode 103 may be printed directly onto product 101 utilizing conventional printing techniques. Alternatively, barcode 103 may be affixed to product 101 utilizing a sticker, tag, etc.

Barcode 103 may be any machine-readable code utilizing either a public standard encoding symbology or a proprietary symbology. Some examples of one and two dimensional symbologies include, but are not limited to, UPC-A, UPC-E, ISBN, RSS-14, RSS-14E, RSS-14L, Interleaved 2 of 5, EAN/JAN-8, EAN/JAN-13, Code 39, Code 39 Full ASCII, Code 128, PDF417, QR Code, Data Matrix, and Optical Intelligence 2D.

To scan barcode 103, a user utilizes mobile device 105 with attached or embedded digital camera 107. Mobile device 105 may be any device capable of digitally imaging barcode 103 such as a camera phone, mobile phone with camera attachment, PDA, PDA with camera attachment, Pocket PC, Palm device, laptop, desktop, etc.

First, the user takes a picture of barcode 103 using embedded digital camera 107. Once an image of barcode 103 has been acquired by mobile device 105, the barcode image is sent to server 113 via MMS message 111 through wireless network 109. ScanZoom software loaded on server 113 decodes the barcode.

Server 113 may process the decoded barcode information in many different ways. In a first embodiment, server 113 may use relational database 114 to pull up product information pertaining to product 101. The server would then forward the product information to mobile device 105 via a SMS/MMS message. If a MMS message is sent to mobile device 105, this may cause a WAP browser loaded on mobile device 105 to be redirected to the appropriate site. The MMS message may also forward a “link” to the user which can be used to direct mobile devices' 105 to a website.

However, on some devices, sending a link as an MMS is not an option. For these devices, a SMS message can be sent to mobile device 105 which contains a link which can be added to the user's favorites/bookmarks. An additional SMS message can also be sent to indicate to the user that the barcode has been properly decoded.

In a second embodiment, server 113 may process the decoded barcode information by using relational database 114 to pull up product information related to product 101 and then utilize search engine 117 to search for similar products or information pertaining to it. The results of the search would then be sent to mobile device 105 via a SMS/MMS message. As should be evident from these two described embodiments, the barcode information can be utilized in an almost limitless amount of ways.

To provide additional security, a user of mobile device 105 may be prompted to provide a username and/or password to access server 113. Server 113 would use user database 119 to properly authenticate users. Users not having an account contained in user database 119 would not be granted access to server 113 in any capacity.

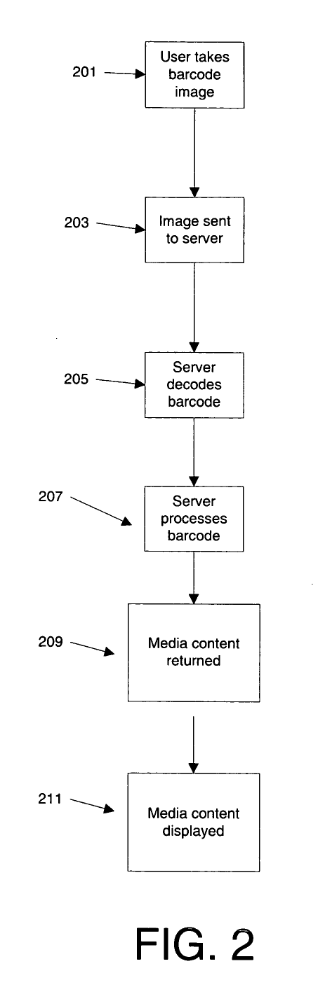

Referring next to FIG. 2, shown is the process utilized by ScanZoom to decode barcode 103. A user first takes a picture of barcode 103 in step 201. Generally, the user utilizes a “preview” window to properly center and align the barcode before taking the picture. After the barcode image has been acquired, the user sends the picture to server 113 via wireless network 109 in step 203. For example, the picture may be sent to server 113 via MMS message 111. However, any protocol or message type which allows for the communication of images over a wireless network may be utilized with the present invention.

After the barcode image has been received by server 113, it is decoded by the ScanZoom software in step 205. Decoding barcode 103 generally involves two steps. First, the barcode image is processed by server 113 to enhance the barcode image. This allows the barcode to be decoded more easily. Once the barcode image has been enhanced, decoding engine 303 decodes the barcode information from the barcode image. If the software cannot decode barcode 103 on a first attempt in step 205, the ScanZoom software attempts to decode the image a finite amount of times utilizing different parameters.

The barcode information can then be processed by server 113 in step 207. For example, server 113 may use relational database 114 to look up product information pertaining to the decoded barcode information. This media content is then sent back to mobile device 105 in step 209. Preferably, the media content is sent to mobile device 105 via a SMS message or a MMS message, as these are two commonly used methods of transmitting information among wireless devices. However, any method of transmitting media content from server 113 to mobile device 105 may be utilized with the present invention. After the media content has been received by mobile device 105, it is subsequently displayed to the user in step 211.

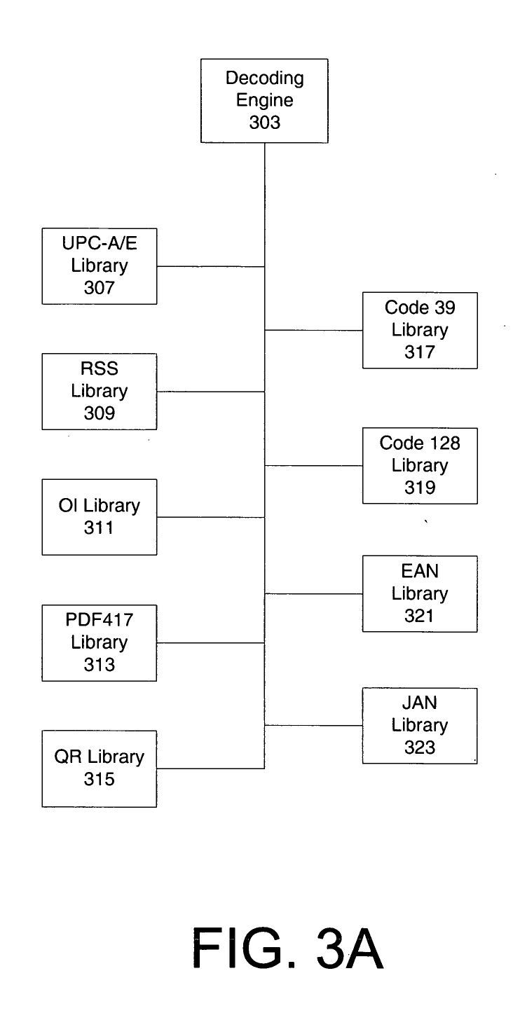

Turning next to FIG. 3, shown is a schematic diagram depicting the product architecture of the ScanZoom software. Decoding engine 303 (utilized in step 205 of FIG. 2) is responsible for decoding barcode 103 acquired via digital camera 107. Decoding engine 303 is designed to accommodate variations in brightness and contrast in the scanned image of barcode 103. This is done through use of globally and locally adaptive image processing operations. Exposure levels can be very high or very low, without significant adverse affect on success of decoding. If contrast is low either because the ink presents little contrast with the substrate, or because the lighting conditions are poor, decoding engine 303 may still decipher barcode 103. Even highly variable shading within an image is recognized and compensated for. The underlying technique utilized by decoding engine 303 to recognize features of barcode 103 is the detection of local pixel intensity patterns that may signal the presence of particular barcode features. This is in contrast to the approach of typical decoding algorithms for more highly controlled commercial scanner or laser gun environments which typically do fixed thresholding or limited digital filtering which presumes a highly controlled environment and lighting configuration.

Decoding engine 303 is able to decode one and two dimensional barcodes with a CIF (typically 352×288) imager, and essentially all commonly used barcodes with a VGA (640×480) imager. Increasing the imager resolution generally improves the usability, decoding speed, and accuracy while increasing the range of viable barcodes.

In ordinary application usage, decoding engine 303 does not require special illumination sources due to its ability to decode barcodes from images with low contrast. For color imagers, decoding engine 303 utilizes specific image processing algorithms in order to avoid problematic image artifacts during the translation from color to grayscale. Decoding engine 303 utilizes fast image processing algorithms to perform the conversion so that the maximum amount of information is preserved, making for a robust, easy to use reader.

Decoding engine 303 is also able to cope with moderate amounts of image focus global impairment due to distance and lens focal length issues. Additionally, the decoding algorithm is optimized to work reliably even with appropriate low-cost lenses in inexpensive consumer digital cameras.

Furthermore, decoding engine 303 is designed to perform reliably in difficult decoding situations. It is successful in variable light, low contrast, low resolution, focus, and other impaired conditions. These abilities make decoding engine 303 perfectly suited to decode barcode images in a variety of “real world” embedded digital camera device conditions.

More specifically, key technical decoding features used in decoding engine 303 include:

Rotation:

Decoding engine 303 enables identification and decoding of most barcodes at any degree of rotation from the normal orientation. Decoding engine 303 is designed for the more general “any orientation” case.

Geometric Distortions:

Decoding engine 303 is tolerant of “aspect ratio,” “shear,” “perspective,” and other geometric image distortions. These distortions can be caused by a number of things such as the camera line of focus not being perpendicular to the plane of the barcode. Specific algorithms can tolerate deviations from the perpendicular in any direction.

Adaptive Correction:

One of the techniques used in several ways by decoding engine 303 is an adaptive, “multiple hypotheses” approach to detect the presence of specific features within barcode 103. In general, while decoding an image of barcode 103, a number of assumptions are made by decoding engine 303 about how characteristic features of barcode 103 are likely to appear in an image. For example, the precise width and intensity of a minimal bar in an image and the threshold at which a data bit in a matrix code is counted as on or off are critical to decoding an image. Initial default estimates of these parameters may be wrong, and only by adaptively correcting them can the image be decoded. Where appropriate, decoding engine 303 will re-examine an image that has failed to decode under one set of assumptions and introduce revised assumptions to improve the likelihood of correctly decoding barcode 103.

Error Correction:

Decoding engine 303 additionally makes use of sophisticated error correction technology for two-dimensional barcode formats. The standard technique for error correction in dense barcodes is some variant of a “Reed-Solomon” algorithm. Decoding engine 303 uses the full power of this approach. Reed-Solomon techniques can correct a limited number of errors in these guesses. Decoding engine 303 makes guesses on most elements, but also identifies elements that are too poorly imaged or printed to make a reasonable guess. These are “erasures.” Reed-Solomon error correction techniques can detect and correct more errors and thus has improved general results when erasures are identified.

Sub-Pixel Precision:

Decoding engine 303 also allows barcode information to be resolved to sub-pixel precision. The algorithms need to, and can, with certain barcode types, retrieve information from a code element occupying an area less than 1.5×1.5 pixels. Among the techniques employed by decoding engine 303 are specialized adaptive interpolation algorithms that take into account the precise local conditions surrounding the data feature being examined. Local conditions may include differences in lighting or printing quality, or secondary light scattering. Various image kernel operations are available to enhance the local image quality. The resulting outcome is better decoding accuracy, support for higher density codes, and more robust performance.

Decoding engine 303 may utilize any number of symbol libraries to resolve the correct barcode information. As shown, decoding engine 303 may access UPC-A/E library 307, RSS library 309, OI library 311, PDF417 library 313, QR code library 315, Code 39 library 317, Code 128 library 319, EAN library 321, and JAN library 323.

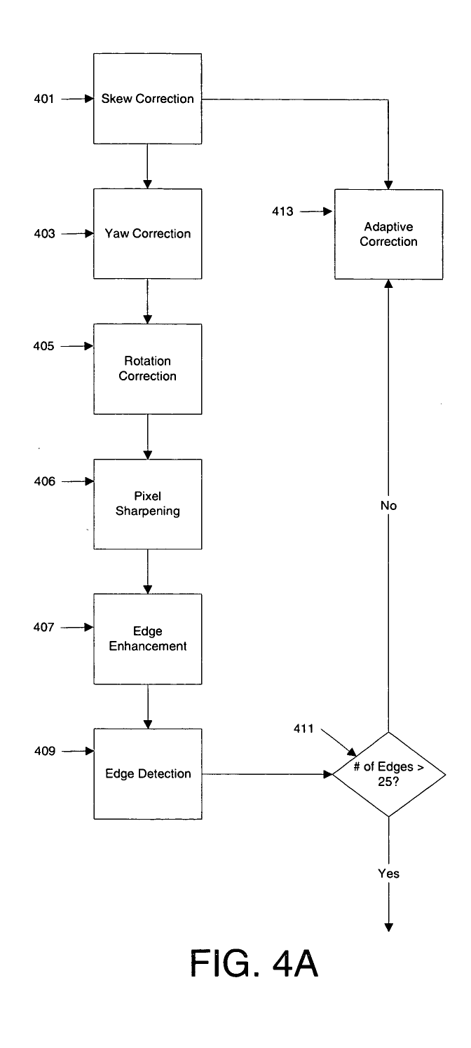

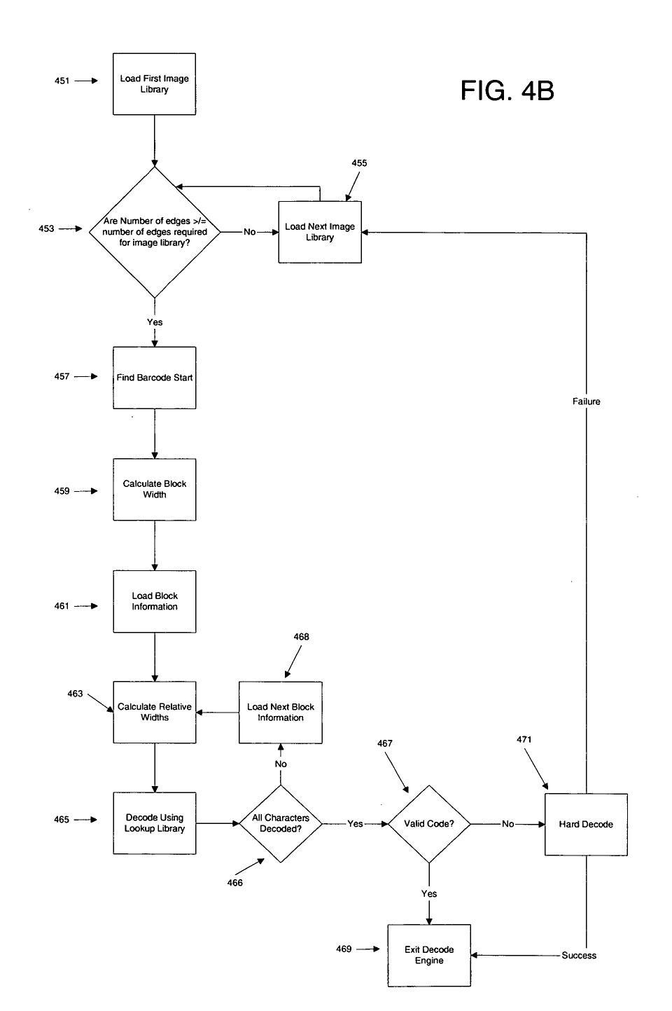

Now referring to FIG. 4A, shown is a flowchart of the steps utilized by decoding engine 303 to enhance the image of barcode 103. First, decoding engine 303 converts the barcode image to a black and white image using a standard image filter in step 400. Afterward, decoding engine 303 de-skews the barcode image in step 401. Generally, skew occurs when the barcode picture is taken at an angle. To compensate for this effect, decoding engine 303 first identifies the angle(s) of skew in the image and processes the picture accordingly to remove the skew.

Next, decoding engine 303 attempts to repair images which exhibit yaw in step 403. Yaw occurs when the barcode or camera is moved during exposure, causing the image to exhibit streaks. Decoding engine 303 removes the yaw from images by using a filter specifically designed to remove such effects.

Once the skew and yaw in the image has been corrected, decoding engine 303 attempts to remove any rotation of the barcode from the normal orientation which may have occurred during imaging. This may be accomplished in a variety of ways in step 405. For example, decoding engine 303 may first identify the angle of rotation of the image. This is much simpler for one-dimensional barcodes, but is also possible for two-dimensional barcodes. For one-dimensional barcodes, decoding engine 303 only has to calculate the angle at which the parallel bars in the barcode are rotated from the normal orientation. Once this has been determined, decoding engine 303 can apply a rotation function to the image to return the barcode image to the normal orientation.

Returning two-dimensional barcodes to a normal orientation requires much more processing because two-dimensional barcodes contain data in both the horizontal and vertical directions. To determine the angle of rotation, the barcode must be analyzed from at least two orientations, preferably perpendicular to each other. The results of the two analyzations can then be utilized to determine the angle of rotation of the two-dimensional barcode. The same rotation function used for one-dimensional barcodes, previously described, can also be used for two-dimensional barcodes to return the barcode image to the normal orientation.

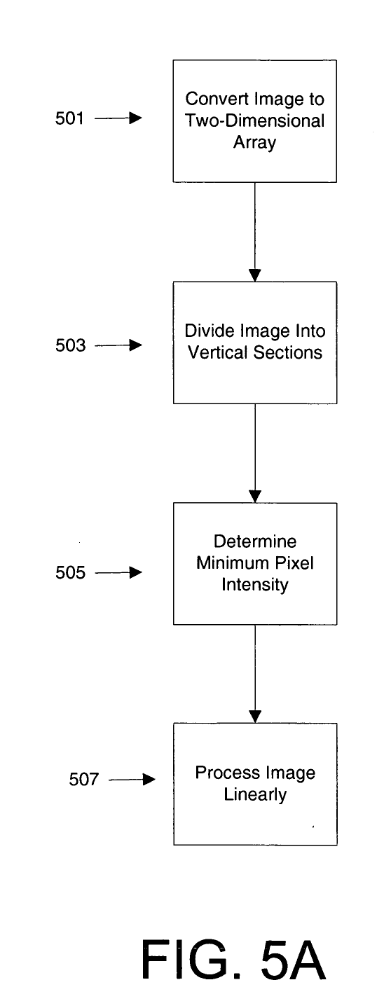

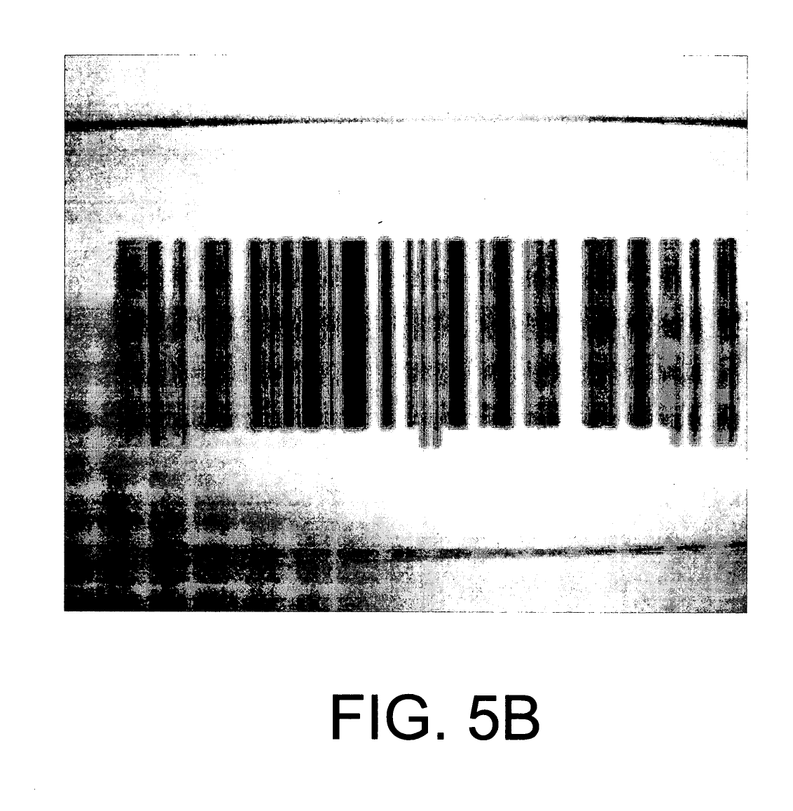

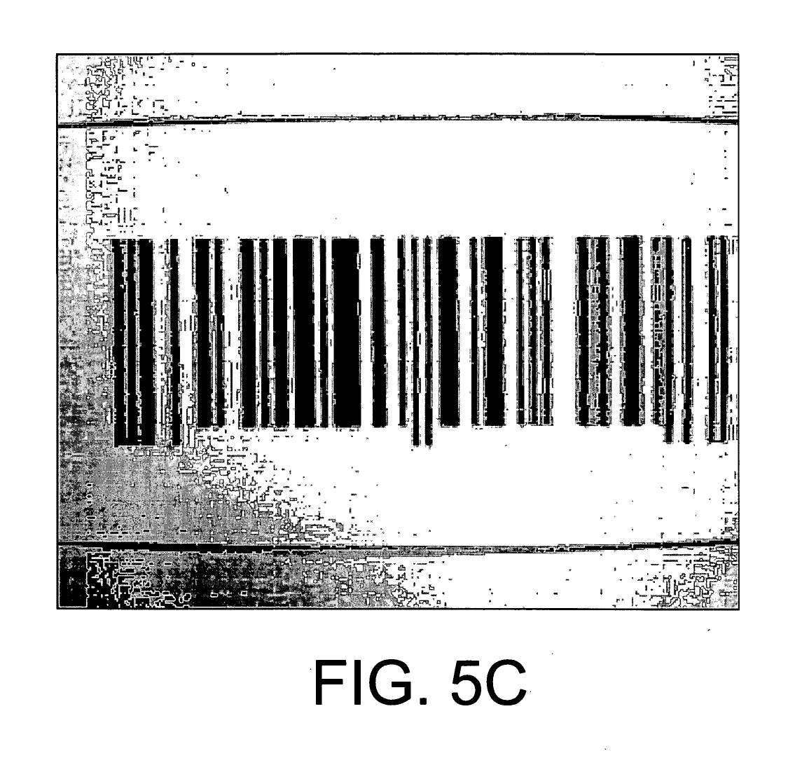

Next, decoding engine 303 sharpens the image using either a standard sharpening filter or a proprietary filter in step 406. The sharpening filter algorithm, described in FIG. 5A, has been shown to be effective for sharpening images containing barcodes. First, the sharpening algorithm converts the gray-scale barcode image is broken down into a two-dimensional array in step 501. Each entry in the two-dimensional array stores the horizontal and vertical coordinates (i.e., the “x” and “y” coordinates) of a single pixel. The image is then divided into an equal number of vertical sections in step 503. The number of sections (“ns”) is equal to the width of the image (in pixels) divided by the desired width of the sections (“ws”). The width of the sections can either be user defined or automatically defined depending upon the size of the image. This converts the image to a three-dimensional array since each pixel also has an assigned section.

After the image has been divided into sections, the sharpening algorithm determines the minimum intensity of a pixel in each section in step 505. The image is then processed linearly section by section in step 507. This is done by assigning a pixel intensity of zero to all pixel intensities which are below a threshold black level. The threshold black level is initially user-defined and changes for each image or section being processed depending upon a threshold modulator. In contrast, all pixel intensities having a pixel value above a threshold white value are assigned a pixel intensity of 255.

A pixel is also assigned a zero intensity if:
1. The value of the pixel lies within a predetermined range of the minimum pixel intensity for that section; or
2. The intensity of pixels surrounding a certain pixel has an intensity that lies within the predetermined range of minimum pixel intensity for that section.

After the image of the barcode has been processed in step 507, the sharpening algorithm renders the processed image sections back into an image. An example input and output barcode which have been processed by the aforementioned sharpening algorithm are shown in FIG. 5B and FIG. 5C, respectively. The outputted image of FIG. 5C has a much higher chance of being properly decoded than the inputted image of FIG. 5B.

Now referring back to FIG. 4A, decoding engine 303 applies an edge enhancement filter to the image in step 407. This further removes any image anomalies which may have occurred during imaging or conversion to black and white. Once the edges are enhanced, decoding engine 303 counts the number of edges which occur in the barcode image in step 409. An edge is a point in the image where there is a sudden change in the color values of the image. An edge that defines a transition from white to black (light to dark) is called a rising edge and an edge that defines the transition from black to white (dark to light) is called a falling edge. Since the quality of the image returned by the camera of the cell phone isn't of a very good quality, the edge detection process relies on the series of approximations and sub processes. Thus the edge detection of step 409 returns a collection of edges (i.e., points where it is believed that the value of the color changed from dark to light or light to dark).

If the number of detected edges is less than 25 as checked in step 411, decoding algorithm 303 attempts to adjust the barcode image again using a new set of assumptions in step 413. The image is then reprocessed using an unaltered version of the image stored in a buffer. If more than 25 edges are not detected after a number of iterations, the ScanZoom application informs the user that a barcode could not be located and the application terminates.

However, if the number of edges if found to be greater than or equal to a certain minimum defined number, decoding engine 303 advances to the flowchart of FIG. 4B. As shown in the flowchart, decoding engine 303 loads a first symbology library in step 451. The symbology library may be UPC-A/E library 307, RSS library 309, OI library 311, PDF417 library 313, QR code library 315, Code 39 library 317, Code 128 library 319, EAN library 321, and JAN library 323 (see FIG. 3). Decoding engine then compares the number of edges a barcode needs to be in this library to the number of edges detected in the actual scanned barcode in step 453. If the number of edges does not match, decoding engine 303 loads the next symbology library in step 455 and repeats the edge comparison with the new library. Detection engine 303 continues this comparison until a match is found.

When a match is found in step 453, decoding engine 303 proceeds to find the start of the barcode in step 457. Decoding engine 303 next calculates the width of each block in the barcode in step 459.

Decoding engine 303 then loads the barcode information from the first block (i.e., the width of the two bars and two spaces contained within the first block) in step 460. The strip width of the first block can then be calculated in step 461. Using the strip width, decoding engine 303 calculates the relative widths of each bar/space in the block in step 463. The relative width is defined to be the width of the bar or space divided by the strip width. The resulting relative widths can then be used to calculate the first character of the barcode utilizing a lookup table for the first symbology library.

Decoding engine 303 next determines whether all of the characters have been decoded in step 466. If all the characters have not been decoded, decoding engine 303 loads the information from the next block in step 468 and repeats steps 463-465 until all characters are decoded from all blocks. Once this has been accomplished, decoding engine 303 determines if the decoded character set is a valid code according to the first symbology library in step 467. If the code is valid, decoding engine 303 terminates in step 469 and the barcode data is forwarded to the messaging system (see FIG. 2, step 209).

However, if the code is not valid according to the first symbology library, decoding engine 303 attempts a “force decode” in step 471 utilizing an alternative method of decoding. If this method is successful, decoding engine 303 terminates in step 469 and the barcode data is forwarded to the messaging system (see FIG. 2, step 209). If not, decoding engine 303 loads the next symbology library and repeats steps 453-467 until a valid code is found according to the loaded symbology library.

While the foregoing embodiments of the invention have been set forth in considerable detail for the purposes of making a complete disclosure, it should be evident to one skilled in the art that multiple changes may be made to the aforementioned description without departing from the spirit of the invention.

1. A method of decoding and analyzing a barcode comprising the steps of:
imaging a barcode with mobile device equipped with a digital camera;
transmitting the barcode image to a server via a wireless network;
enhancing said barcode image utilizing said server;
decoding the barcode information from said enhanced barcode image utilizing said server;
processing said barcode information using said server to determine the media content associated with said barcode information; and
transmitting said media content to the mobile device via said wireless network.

2. A method of decoding and analyzing a barcode according to claim 1, wherein said enhancing of said barcode image by said server comprises at least one of the steps of:
correcting said barcode image for skew;
correcting said barcode image for yaw;
correcting said barcode image for barcode sizing;
correcting said barcode image for rotation of said barcode from the normal position;
sharpening the pixels in said barcode image; and
enhancing the edges of said barcode in said barcode image.

3. A method of decoding and analyzing a barcode according to claim 1, wherein said decoding of said barcode comprises the steps of:
calculating the number of edges in said barcode image;
loading a first symbology library;
comparing said number of edges to a predetermined threshold require for said symbology library; and
decoding said barcode from said barcode image utilizing said symbology library.

4. A method of decoding and analyzing a barcode according to claim 3, wherein a plurality of other symbology libraries are loaded if said number of edges is less than said predetermined threshold.

5. A method of decoding and analyzing a barcode according to claim 3, wherein said step of decoding said barcode from said barcode image utilizing said symbology library comprises the steps of:
locating the start of said barcode in said barcode image;
calculating the width of character blocks within said barcode image;
calculating the relative widths of each bar and space within said character blocks; and
decoding each character from said character blocks utilizing said symbology library.

6. A method of decoding and analyzing a barcode according to claim 5, wherein said step of decoding said barcode from said barcode image utilizing said symbology library comprises the steps of:
verifying that said decoded barcode information is valid utilizing a checksum calculation.

7. A method of decoding and analyzing a barcode according to claim 1, wherein said mobile device is at least one of the group consisting of a camera phone, mobile phone, smart phone, PDA, pager, pocket PC or laptop computer.

8. A method of decoding and analyzing a barcode according to claim 1, wherein said barcode is constructed from at least one of the standardized barcode symbology libraries consisting of the group of UPC-A, UPC-E, ISBN, RSS-14, RSS-14E, RSS-14L, Interleaved 2 of 5, EAN/JAN-8, EAN/JAN-13, Code 3, Code 39 Full ASCII, Code 128, PDF417, QR Code, or Data Matrix.

9. A method of decoding and analyzing a barcode according to claim 1, wherein said media content is a search result of a database constructed from said barcode information.

10. A method of decoding and analyzing a barcode according to claim 1, wherein said media content transmitted to said mobile device is product information.

11. A method of decoding and analyzing a barcode according to claim 1, wherein said wireless network is a WAP network.

12. A method of decoding and analyzing a barcode according to claim 1, wherein said barcode image is transmitted to said server via a MMS message.

13. A system for decoding and analyzing a barcode comprising:
at least one machine readable barcode;
at least one mobile device equipped with a digital camera for imaging said barcode to create a barcode image;
a wireless network; and
a server for receiving said barcode image, decoding said barcode image to extract barcode information, processing said barcode information via said wireless network, wherein said server transmits media content to said mobile device after processing said barcode information.

14. A system for decoding and analyzing a barcode according to claim 13, wherein said server enhances said barcode image by performing the steps of:
correcting said barcode image for skew;
correcting said barcode image for yaw;
correcting said barcode image for barcode sizing;
correcting said barcode image for rotation of said barcode from the normal position;
sharpening the pixels in said barcode image; and
enhancing the edges of said barcode in said barcode image.

15. A system for decoding and analyzing a barcode according to claim 13, wherein said decoding of said barcode by said mobile device comprises the steps of:
calculating the number of edges in said barcode image;
loading a first symbology library;
comparing said number of edges to a predetermined threshold require for said symbology library; and
decoding said barcode from said barcode image utilizing said symbology library.

16. A system for decoding and analyzing a barcode according to claim 15, wherein said step of decoding said barcode from said barcode image utilizing said symbology library comprises the steps of:
locating the start of said barcode in said barcode image;
calculating the width of character blocks within said barcode image;
calculating the relative widths of each bar and space within said character blocks; and
decoding each character from said character blocks utilizing said symbology library.

17. A system for decoding and analyzing a barcode according to claim 15, wherein a plurality of other symbology libraries are loaded by said mobile device if said number of edges is less than said predetermined threshold.

18. A system for decoding and analyzing a barcode according to claim 13, wherein said mobile device is at least one of the group consisting of a camera phone, mobile phone, smart phone, PDA, pager, pocket PC, desktop, or laptop computer.

19. A system for decoding and analyzing a barcode according to claim 13, wherein said barcode is constructed from at least one of the standardized barcode symbology libraries consisting of the group of UPC-A, UC-E, ISBN, RSS-14, RSS-14E, RSS-14L, Interleaved 2 of 5, EAN/JAN-8, EAN/JAN-13, Code 3, Code 39 Full ASCII, Code 128, PDF417, QR Code, or Data Matrix.

20. A system for decoding and analyzing a barcode according to claim 13, wherein said media content is a search result of a database constructed from said barcode information.

21. A system for decoding and analyzing a barcode according to claim 13, wherein said media content transmitted to said mobile device is product information about said manufactured good.

22. A system for decoding and analyzing a barcode according to claim 13, wherein said wireless network is a WAP network.

23. A system for decoding and analyzing a barcode according to claim 13, wherein said barcode image is transmitted to said server via a MMS message.

24. A method of decoding and analyzing a barcode according to claim 1, wherein said media content is transmitted to said mobile device via a MMS message.

25. A method of decoding and analyzing a barcode according to claim 1, wherein said media content is transmitted to said mobile device via a SMS message.
